(19) United States
(12) Patent Application Publication
(10) Pub. No.: US 2013/0208091 A1
(43) Pub. Date: Aug. 15, 2013

(54) AMBIENT LIGHT ALERT FOR AN IMAGE SENSOR

(71) Applicants: Giora Yahav, Haifa (IL); David Cohen, Nesher (IL); Guy Gilboa, Kiryat Tivon (IL)

(72) Inventors: Giora Yahav, Haifa (IL); David Cohen, Nesher (IL); Guy Gilboa, Kiryat Tivon (IL)

(73) Assignee: MICROSOFT CORPORATION, Redmond, WA (US)

(21) Appl. No.: 13/396,297

(22) Filed: Feb. 14, 2012

(51) Int. Cl. H04N 13/02; H04N 7/18

(52) U.S. Cl. 348/46; 348/135; 348/E07.085

(57) ABSTRACT

An image camera component and its method of operation are disclosed. The image camera component detects when ambient light within a field of view of the camera component interferes with operation of the camera component to correctly identify distances to objects within the field of view of the camera component. Upon detecting a problematic ambient light source, the image camera component may cause an alert to be generated so that a user can ameliorate the problematic ambient light source.

### BACKGROUND

Gated three-dimensional (3-D) cameras, for example time-of-flight (TOF) cameras, provide distance measurements to objects in a scene by illuminating a scene and capturing reflected light from the illumination. The distance measurements make up a depth map of the scene from which a 3-D image of the scene is generated.

Ambient lighting of a captured scene can interfere with the light provided by the 3-D camera and can result in incorrect distance measurements. As used herein, “ambient light” is any light not supplied by the 3-D camera. It is therefore known to compensate for moderate levels of ambient light. In one example, the 3-D camera captures a frame of ambient light, while light from the 3-D camera is turned off or otherwise not received by the camera. The measured ambient light is thereafter subtracted from the light emitted by and reflected to the 3-D camera to allow for accurate distance measurement based on light from the camera alone.

It may happen that an ambient light source is too high and affects too many of the pixels for the camera to provide reliable distance measurements. In this instance, the 3-D camera indicates a malfunction and does not provide distance measurements.

### SUMMARY

Embodiments of the present technology, roughly described, relate to an image camera component and its method of operation. The image camera component detects when ambient light within a field of view of the camera component interferes with operation of the camera component to correctly identify distances to objects within the field of view of the camera component. Upon detecting a problematic ambient light source, the image camera component may cause an alert to be generated so that a user can ameliorate the problematic ambient light source.

The alert may include displaying a representation of the problematic ambient light source, and a position of the user relative to the problematic ambient light source. The alert may further include an indication of the degree of interference of the problematic ambient light source. In embodiments, the alert may further suggest an action to ameliorate the problem.

In one example, the present technology relates to a method of detecting a problematic ambient light source using an image camera component capturing a field of view, the method comprising: (a) measuring ambient light within the field of view; (b) determining whether the amount of ambient light measured in said step (a) interferes with the operation of the image camera component; and (c) alerting a user as to the existence of the problematic ambient light source if it is determined in said step (b) that the amount of ambient light measured in said step (a) interferes with the operation of the image camera component.

A further example of the present technology relates to a method of detecting a problematic ambient light source using an image camera component measuring distances to objects within a field of view, the method comprising: (a) measuring ambient light within the field of view; (b) determining whether photopixels of the image camera component are receiving ambient light at levels which prevent the image camera component from properly measuring distances to objects within the field of view; and (c) alerting a user as to the existence of the problematic ambient light source if it is determined in said step (b) that photopixels of the image camera component are receiving ambient light at levels which prevent the image camera component from properly measuring distances to objects within the field of view.

Another example of the present technology relates to a 3-D camera for measuring distances to objects within a field of view of the 3-D camera, and determining the presence of a problematic source of ambient light, the 3-D camera comprising: a photosurface including a plurality of pixels capable of measuring ambient light; a processor for processing data received from the photosurface, and an ambient light feedback engine executed by the processor for identifying a problematic ambient light source within the field of view from data received from the photosurface, and for alerting a user of the problematic ambient light source when identified so that the user can intervene to ameliorate the problem caused by the problematic ambient light source.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments of the present disclosure will now be described with reference to the following drawings.

FIG. 1A illustrates an example embodiment of a target recognition, analysis, and tracking system in which embodiments of the technology can operate.

FIG. 1B illustrates a further example embodiment of a target recognition, analysis, and tracking system in which embodiments of the technology can operate.

FIG. 2 shows a block diagram of an example of a capture device that may be used in the target recognition, analysis, and tracking system in which embodiments of the technology can operate.

FIG. 3 schematically shows an embodiment of a gated 3-D camera which can be used to measure distances to a scene.

FIG. 4 is a flowchart illustrating operation of an embodiment of the present technology

FIG. 5 is a screen illustration indicating a problematic ambient light source to the user.

FIG. 6 is a user interacting with the target recognition, analysis, and tracking system after correction of the problematic ambient light source.

### DETAILED DESCRIPTION

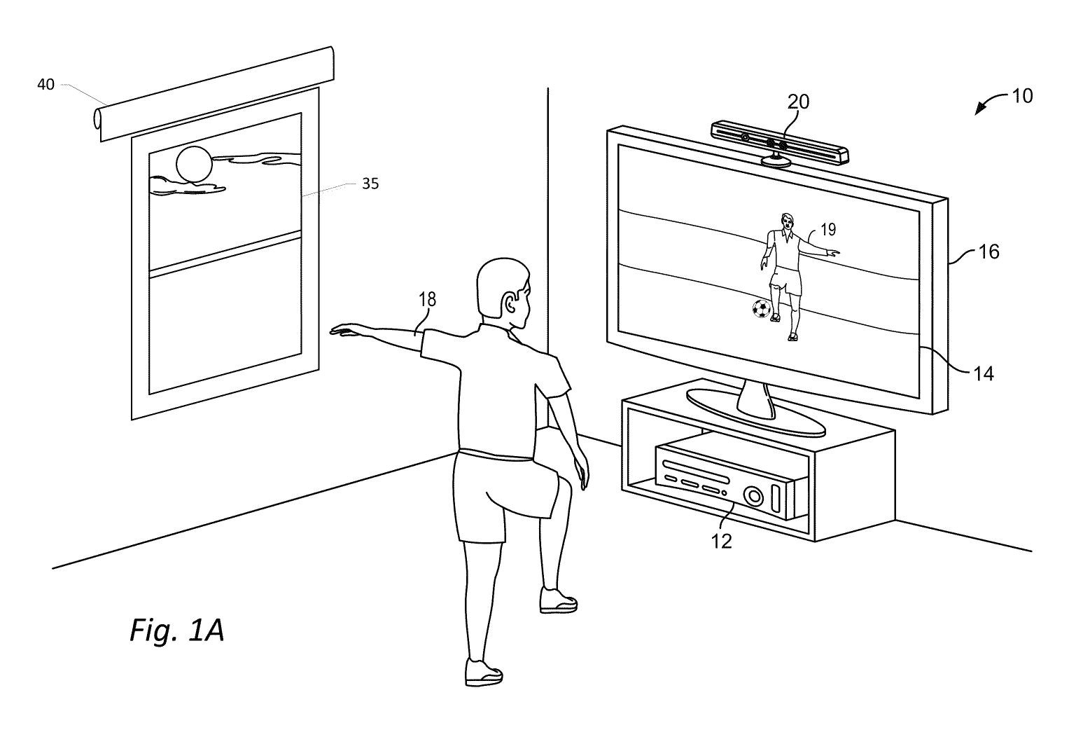

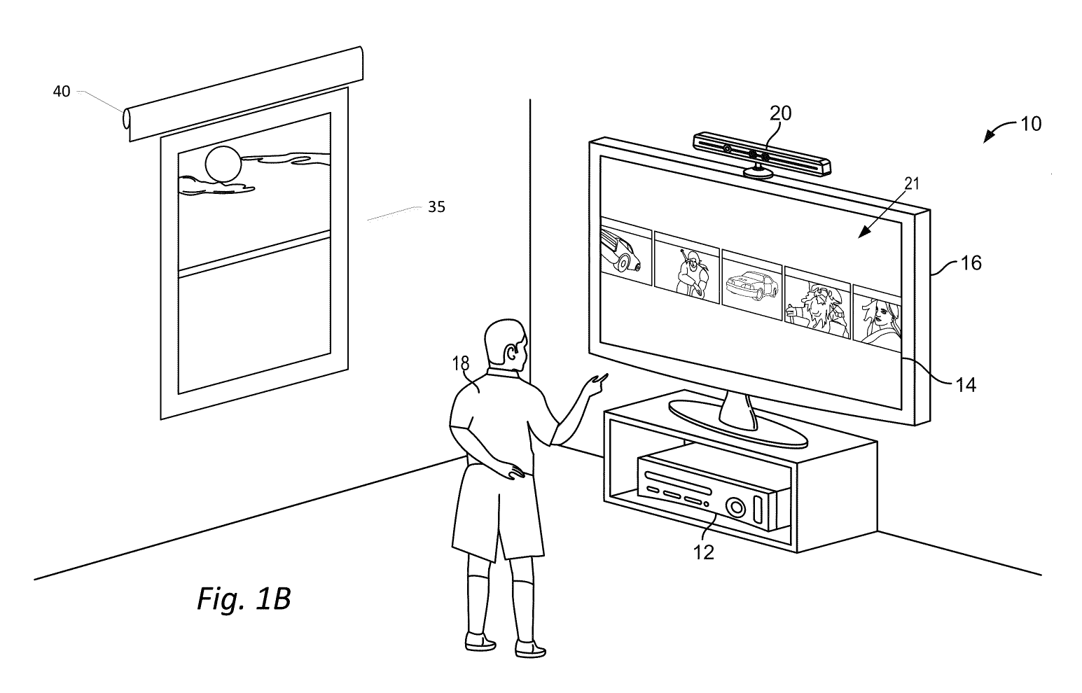

Embodiments of the present disclosure will now be described with reference to FIGS. 1-6 which in general relate to a 3-D camera and a method of its operation. In embodiments, the camera includes a feedback system which measures ambient light and determines presence of a source of ambient light in its field of view (FOV) that is disruptive of satisfactory 3-D operation. Such an ambient light source is at times referred to herein as a problematic ambient light source. Upon recognizing a problematic ambient light source, the feedback system may generate an alert to indicate presence of the problematic source to a user of the 3-D camera. The alert may be provided on a visual display which indicates the location of the source so that the user can remove it, or reduce intensity of the disruption it causes. In some examples, the feedback system may further indicate an example of a corrective action to be undertaken.

Embodiments of the feedback system of the present disclosure may be provided as part of a time-of-flight 3-D camera used to track moving targets in a target recognition, analysis, and tracking system 10. The system 10 may provide a natural user interface (NUI) for gaming and other applications. However, it is understood that the feedback system of the present disclosure may be used in a variety of applications other than a target recognition, analysis, and tracking system 10. Moreover, the feedback system may be used in a variety of 3-D cameras other than time-of-flight cameras which use light to measure a distance to objects in the FOV.

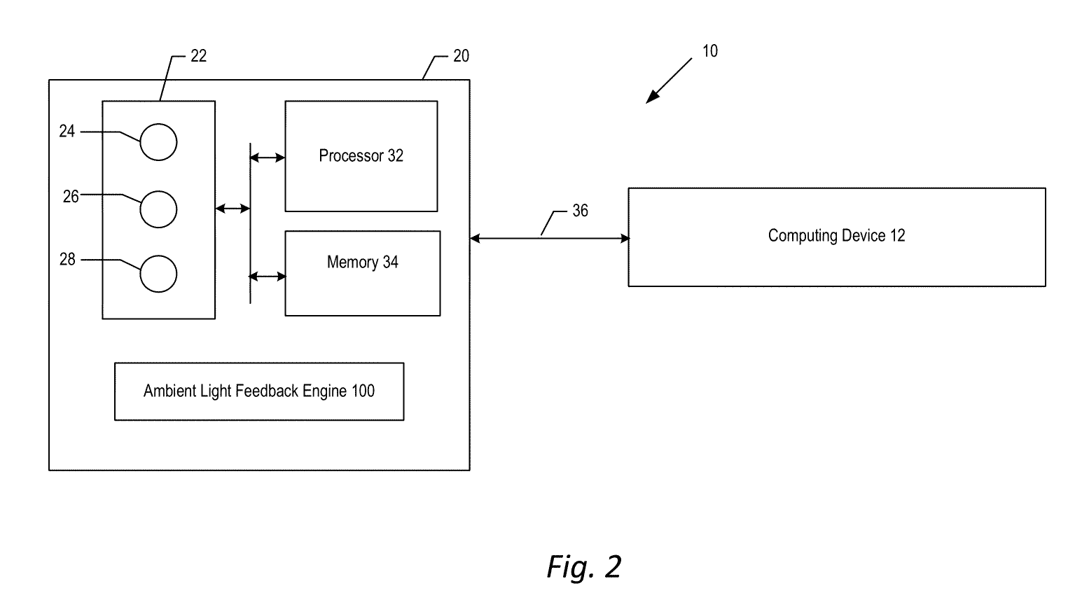

Referring initially to FIGS. 1A-2, there is shown an example of a target recognition, analysis, and tracking system 10 which may be used to recognize, analyze, and/or track a human target such as the user 18. Embodiments of the target recognition, analysis, and tracking system 10 include a computing device 12 for executing a gaming or other application. The computing device 12 may include hardware components and/or software components such that computing device 12 may be used to execute applications such as gaming and non-gaming applications. In one embodiment, computing device 12 may include a processor such as a standardized processor, a specialized processor, a microprocessor, or the like that may execute instructions stored on a processor readable storage device for performing processes of the device 10 when active and running on full power.

The system 10 further includes a capture device 20 for capturing image and audio data relating to one or more users and/or objects sensed by the capture device. In embodiments, the capture device 20 may be used to capture information relating to body and hand movements and/or gestures and speech of one or more users, which information is received by the computing environment and used to render, interact with and/or control aspects of a gaming or other application. Examples of the computing device 12 and capture device 20 are explained in greater detail below.

Embodiments of the target recognition, analysis and tracking system 10 may be connected to an audio/visual (A/V) device 16 having a display 14. The device 16 may for example be a television, a monitor, a high-definition television (HDTV), or the like that may provide game or application visuals and/or audio to a user. For example, the computing device 12 may include a video adapter such as a graphics card and/or an audio adapter such as a sound card that may provide audio/visual signals associated with the game or other application. The A/V device 16 may receive the audio/visual signals from the computing device 12 and may then output the game or application visuals and/or audio associated with the audio/visual signals to the user 18. According to one embodiment, the audio/visual device 16 may be connected to the computing device 12 via, for example, an S-Video cable, a coaxial cable, an HDMI cable, a DVI cable, a VGA cable, a component video cable, or the like.

In embodiments, the computing device 12, the A/V device 16 and the capture device 20 may cooperate to render an avatar or on-screen character 19 on display 14. For example, FIG. 1A shows a user 18 playing a soccer gaming application. The user's movements are tracked and used to animate the movements of the avatar 19. In embodiments, the avatar 19 mimics the movements of the user 18 in real world space so that the user 18 may perform movements and gestures which control the movements and actions of the avatar 19 on the display 14. In FIG. 1B, the capture device 20 is used in a NUI system where, for example, a user 18 is scrolling through and controlling a user interface 21 with a variety of menu options presented on the display 14. In FIG. 1B, the computing device 12 and the capture device 20 may be used to recognize and analyze movements and gestures of a user's body, and such movements and gestures may be interpreted as controls for the user interface.

Suitable examples of a system 10 and components thereof are found in the following co-pending patent applications, all of which are hereby specifically incorporated by reference: U.S. patent application Ser. No. 12/475,094, entitled “Environment and/or Target Segmentation,” filed May 29, 2009; U.S. patent application Ser. No. 12/511,850, entitled “Auto Generating a Visual Representation,” filed Jul. 29, 2009; U.S. application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; and U.S. patent application Ser. No. 12/391,150, entitled “Standard Gestures,” filed Feb. 23, 2009.

FIG. 2 illustrates an example embodiment of the capture device 20 that may be used in the target recognition, analysis, and tracking system 10. In an example embodiment, the capture device 20 may be configured to capture video having a depth image that may include depth values via any suitable technique including, for example, time-of-flight, structured light or the like. According to one embodiment, the capture device 20 may organize the calculated depth information into “Z layers,” or layers that may be perpendicular to a Z axis extending from the depth camera along its line of sight. X and Y axes may be defined as being perpendicular to the Z axis. The Y axis may be vertical and the X axis may be horizontal. Together, the X, Y and Z axes define the 3-D real world space captured by capture device 20.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

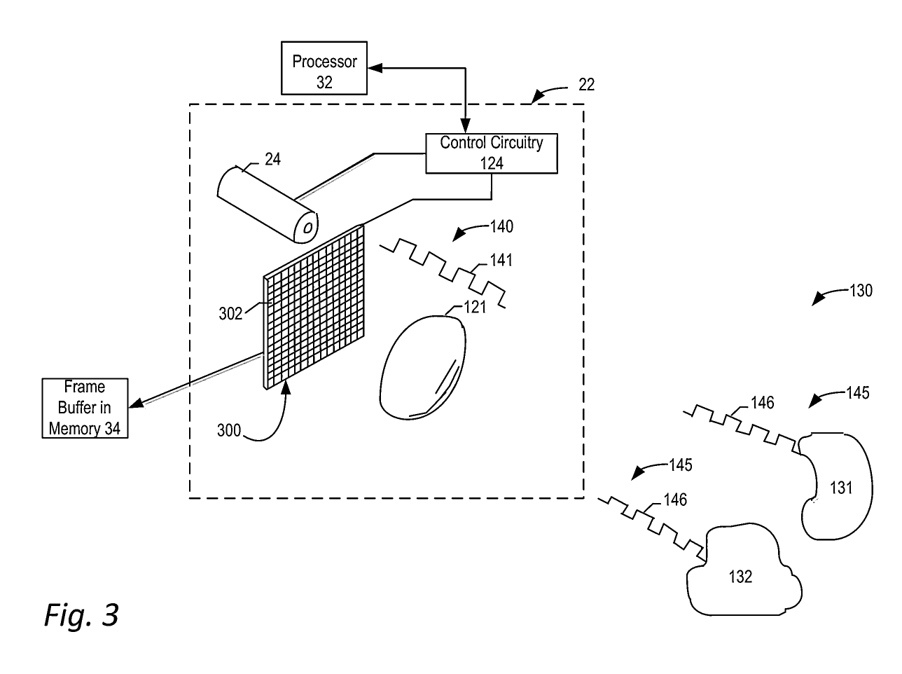

As shown in FIG. 2, according to an example embodiment, the image camera component 22 may include an IR light component 24, 3-D camera 26, and an RGB camera 28 that may be used to capture the depth image of a scene. For example, in time-of-flight analysis, the IR light component 24 of the capture device 20 may emit an infrared light onto the scene and may then use sensors (described in greater detail below with reference to FIG. 3) to detect the backscattered light from the surface of one or more targets and objects in the scene using, for example, the 3-D camera 26 and/or the RGB camera 28.

In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as a grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

In each of the above-described examples, ambient light may affect the measurements taken by 3-D 26 and/or RGB camera 28. Accordingly, the capture device 20 may further include an ambient light feedback engine 100 which is a software engine for detecting a source of ambient light and alerting the user as to the location of the source of the ambient light. Further details of the ambient light feedback engine 100 are explained below. In alternative embodiments, the ambient light feedback engine 100 may be implemented in part or in whole on computing device 12.

In an example embodiment, the capture device 20 may further include a processor 32 that may be in operative communication with the image camera component 22 and ambient light feedback engine 100. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 32. According to another embodiment, the memory component 34 may be integrated into the processor 32 and/or the image camera component 22.

As shown in FIG. 2, the capture device 20 may be in communication with the computing device 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing device 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28. With the aid of these devices, a partial skeletal model may be developed with the resulting data provided to the computing device 12 via the communication link 36.

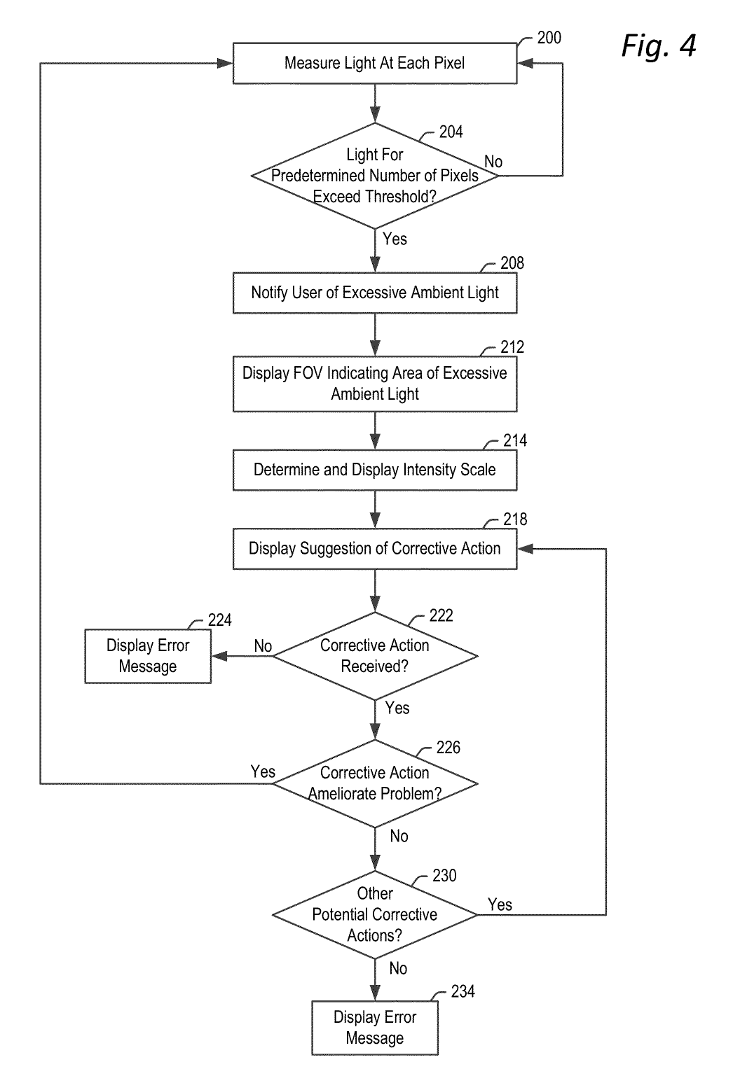

FIG. 3 schematically shows an embodiment of a gated 3-D image camera component 22 which can be used to measure distances to a scene 130 having objects schematically represented by objects 131 and 132. The camera component 22, which is represented schematically, comprises a lens system, represented by a lens 121, a photosurface 300 with at least two capture areas on which the lens system images the scene, and a suitable light source 24. Embodiments of different image capture areas are shown and discussed below for a CCD embodiment in FIG. 4 and a CMOS embodiment in FIG. 7. Some examples of a suitable light source are a laser or an LED, or an array of lasers and/or LEDs, that is controllable to illuminate scene 130 with pulses of light by control circuitry 124.

The pulsing of the light source 24 and the gating of different image capture areas of the photosurface 300 is synchronized and controlled by control circuitry 124. In one embodiment, the control circuitry 124 comprises clock logic or has access to a clock to generate the timing necessary for the synchronization. The control circuitry 124 comprises a laser or LED drive circuit using for example a current or a voltage which drives electronic circuitry to drive the light source 24 at the predetermined pulse width. The control circuitry 124 also has access to a power supply (not shown) and logic for generating different voltage levels as needed. The control circuitry 124 may additionally or alternatively have access to the different voltage levels and logic for determining the timing and conductive paths to which to apply the different voltage levels for turning ON and OFF the respective image capture areas.

To acquire a 3-D image of scene 130, control circuitry 124 controls light source 24 to emit a train of light pulses, schematically represented by a train 140 of square light pulses 141 having a pulse width, to illuminate scene 130. A train of light pulses is typically used because a light source may not provide sufficient energy in a single light pulse so that enough light is reflected by objects in the scene from the light pulse and back to the camera to provide satisfactory distance measurements to the objects. Intensity of the light pulses, and their number in a light pulse train, are set so that an amount of reflected light captured from all the light pulses in the train is sufficient to provide acceptable distance measurements to objects in the scene. Generally, the radiated light pulses are infrared (IR) or near infrared (NIR) light pulses.

During the gated period, the short capture period may have duration about equal to the pulse width. In one example, the short capture period may be 10-15 ns and the pulse width may be about 10 ns. The long capture period may be 30-45 ns in this example. In another example, the short capture period may be 20 ns, and the long capture period may be about 60 ns. These periods are by way of example only, and the time periods in embodiments may vary outside of these ranges and values.

Following a predetermined time lapse or delay, T, after a time of emission of each light pulse 141, control circuitry 124 turns ON or gates ON the respective image capture area of photosurface 300 based on whether a gated or ungated period is beginning When the image capture area is gated ON, light sensitive or light sensing elements such as photopixels, capture light. The capture of light refers to receiving light and storing an electrical representation of it.

In one example, for each pulse of the gated period, the control circuitry 124 sets the short capture period to be the duration equal to the light pulse width. The light pulse width, short capture period duration, and a delay time T define a spatial “imaging slice” of scene 130 bounded by minimum and maximum boundary distances. The camera captures light reflected from the scene during gated capture periods only for objects of the scene located between the lower bound distance and the upper bound distance. During the ungated period, the camera tries to capture all the light reflected from the pulses by the scene that reaches the camera for normalization of the gated light image data.

During segments of both the gated and ungated periods, the light from light component 24 is switched off, and the pixels receive only ambient light. In this way, the ambient light may be measured and subtracted from the light (pulsed and ambient) received in the pixels of the photosurface 300. This allows the ambient light to be subtracted so that the processors may determine distance measurements to objects in the FOV based on light reflected from the light component 24 alone.

Light reflected by objects in scene 130 from light pulses 141 is schematically represented by trains 145 of light pulses 146 for a few regions 131 and 132 of scene 130. The reflected light pulses 146 from objects in scene 130 located in the imaging slice are focused by the lens system 121 and imaged on light sensitive pixels (or photopixels) 302 of the gated ON area of the photosurface 300. Amounts of light from the reflected pulse trains 145 are imaged on photopixels 302 of photosurface 300 and stored during capture periods for use in determining distances to objects of scene 130 to provide a 3-D image of the scene.

In this example, the control circuitry 124 is communicatively coupled to the processor 32 of the image capture device 20 to communicate messages related to frame timing and frame transfer. When a frame capture period ends, the stored image data captured by the photosurface 300 is readout to a frame buffer in memory 34 for further processing, such as for example by the processor 32 and/or computing device 12 of the target recognition, analysis and tracking system 10 shown in FIG. 2.

As described above, moderate levels of ambient light may be corrected for when taking distance measurements with image camera component 22. In operation, however, it may happen that there are high levels of ambient light on at least portions of the FOV. Generally, where a small number of pixels register too much ambient light, these pixels may be disregarded, and the camera component 22 may still return accurate distance measurements. However, where a predetermined number of pixels indicate an amount of ambient light that is too high for correction, the image camera component 22 indicates a malfunction and does not provide distance measurements.

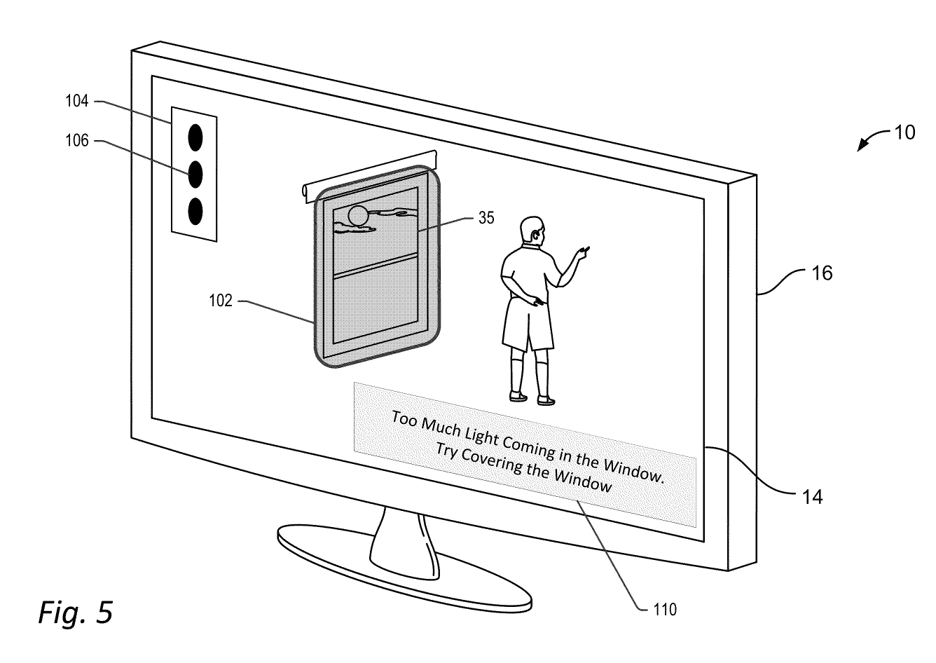

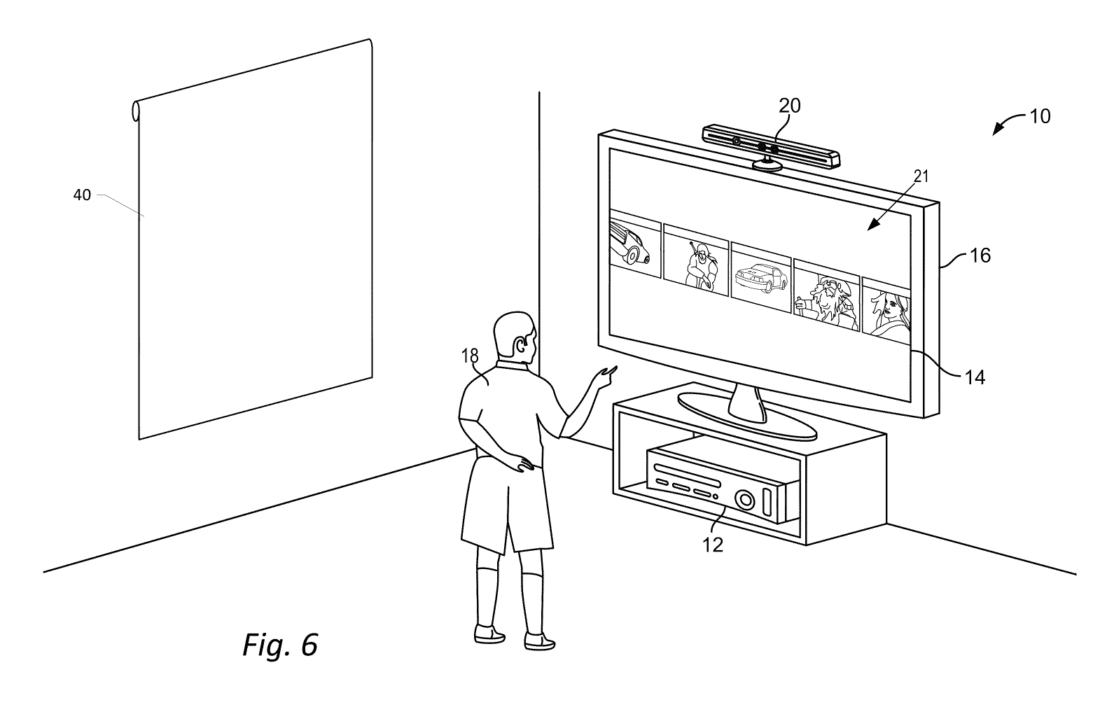

Embodiments of the present disclosure address this problem by implementing an ambient light feedback engine 100, as shown schematically in FIG. 2, and as now explained with reference to the flowchart of FIG. 4 and the illustrations of FIGS. 5 and 6. As noted, examples of the ambient light feedback engine 100 may be implemented by processor 32 associated with the image camera component 22. However, the engine 100 may be implemented by processor 32 of capture device 20 and/or by a processor in the computing device 12.

In a step 200, the amount of light incident on each of the photopixels 302 of photosurface 300 is measured and stored. This may occur during intervals where no light from the IR light component 24 is received on the photosurface 300. Alternatively or additionally, this may occur when the photopixels 302 receive both ambient light and IR light from component 24.

In step 204, the ambient light feedback engine 100 determines whether a predetermined number of photopixels have measured ambient light above a threshold value. A photopixel receiving ambient light above the threshold is referred to herein as an ambient-saturated photopixel. Within each photopixel 302, this threshold value for an ambient-saturated photopixel may be an amount of ambient light which prevents accurate determination of the time of flight of the light from the IR component 24 to that photopixel 302. That is, after the interval where ambient light is measured alone, the image camera component 22 is not able to compensate for the ambient light so that the operation of the image camera component is impaired. In the case of a time of flight 3-D camera, this means that the 3-D camera is not able to properly measure distances to objects within the field of view.

The threshold value for an ambient-saturated photopixel may vary in alternative embodiments. This threshold may be set at a point where ambient light causes even the slightest interference with the determination of distances to objects in the field of view. Alternatively, the threshold may be set at a point where ambient light causes some small but acceptable interference with the determination of distances to objects in the field of view.

Additionally, the number of ambient-saturated photopixels 302 which comprise the predetermined number of ambient-saturated photopixels may vary. The predetermined number of ambient-saturated photopixels may be some number or percentage, for example 10% to 50% of the total number of photopixels 302 on photosurface 300. Alternatively, the predetermined number of ambient saturated photopixels may be reached when a given percentage of photopixels in a certain cluster of photopixels are ambient-saturated. For example, a small lamp in the FOV may provide ambient light which adversely affects only a cluster of photopixels. Where the percentage of ambient-saturated pixels in a cluster of photopixels of a given size exceeds some percentage, for example above 50%, this may satisfy the condition of step 204. The percentages given above are by way of example only, and may vary above or below those set forth in further embodiments.

It is further understood that the condition of step 204 may be satisfied by some combination of the percentage of overall photopixels which are ambient-saturated and the percentage of photopixels within a given cluster of photopixels that are ambient-saturated.

If the number of ambient-saturated photopixels is less than the predetermined number in step 204, the engine 100 returns to step 200 for the next measurement of light incident on the photopixels. On the other hand, if the number of ambient-saturated photopixels exceeds the predetermined number in step 204, the engine 100 performs one or more of a variety of steps to notify the user of a problem with an ambient light source in the FOV and, possibly, suggest corrective action.

For example, in step 208, the ambient light feedback engine 100 may notify the user of an excessive ambient light source in the FOV. This notification may be performed by a variety of methods. For example, the engine 100 may cause the computing device 12 to display an alert on the display as to the problematic ambient light source. Alternatively, the alert may be audible over speakers associated with the device 10.

As a further notification, in step 212, the engine 100 may identify the location of the problematic ambient light source by examining which photopixels 302 are affected. Once the area is identified, the FOV may be shown to the user on display 14 with the problematic ambient light source highlighted on the display. For example, FIGS. 1A and 1B show a user 18 in a room with a window 25. The daylight coming into the window 25 may be providing too much ambient light. As such, in step 212, the engine 100 may cause the computing device 12 to display the FOV with the problematic ambient light source highlighted, as shown for example in FIG. 5. In FIG. 5, the displayed FOV shows highlighting 102 around the window 25 to indicate that that is the source of the problem.

The problematic ambient light source may be highlighted with an outline 102 around the light source, as shown in FIG. 5. Alternatively or additionally, the problematic area may be highlighted by shading, as also shown in FIG. 5. The location of the problematic ambient light source may be highlighted in other ways in further embodiments. The view of FIG. 5 may also show the user positioned relative to the problematic light source to make it easier for the user to identify the location of the problematic ambient light source. The view of the scene captured by capture device 20 may be displayed to the user on display 14 from a variety of different perspectives using known transformation matrices so that the position of the problematic light source relative to the user may be clearly displayed to the user on display 14.

The representation of the user and problematic light source displayed to the user may be an animation including an icon representing the highlighted ambient light source and an icon representing the user 18. Alternatively, it may be video captured by the capture device 20 showing the user and the problematic ambient light source, with the highlight 102 added to the video.

In FIG. 5, the view of the user and problematic light source takes up essentially the full display 14. In further embodiments, the view shown in FIG. 5 may be made smaller, so that it is placed on a portion of the display 14, with the remainder of the screen still showing the original content the user was viewing/interacting with.

It is conceivable that there is more than one discrete area in the FOV having a problematic ambient light source. Each such problematic area may be identified in steps 200 and 204, and shown to user 18 in step 212.

In step 214, the ambient light feedback engine 100 may also determine and display an intensity scale 104 (FIG. 5) indicating the degree, or magnitude, of interference of the problematic ambient light source. As described above, the processor 32 in the capture device 20 can determine the number of photopixels affected by the problematic ambient light source. The number and proximity of affected photopixels can be translated into a degree of interference, and that degree can be displayed to the user in step 214. FIG. 5 shows an intensity scale 104 comprised of a number of dots 106. However, the degree of interference can be relayed graphically to the user 18 over display 14 in any of a variety of different ways, including by the length of a bar, a color intensity map, etc. Step 214 and the intensity scale 104 may be omitted in further embodiments.

In embodiments, the ambient light feedback engine 100 may further suggest one or more corrective actions in steps 218-230. For example, given the measured amount of ambient light, and the shape pattern of the ambient light, the engine 100 may be able to characterize the source of light by comparison to data representing predefined light sources stored in memory (memory 34 in capture device 20, or memory within the computing device). For example, where it is determined that the problematic ambient light is in the shape of a rectangle on a wall within the FOV, the engine 100 may interpret this as a window. Where it is determined that the problematic ambient light is in the shape of a circle or oval within the FOV, the engine 100 may interpret this as a lamp or light fixture in the FOV. Other examples of known ambient light sources are contemplated.

Where the engine 100 is able to identify the source of problematic ambient light, the engine 100 may suggest a corrective action in step 218. For example, as shown in FIG. 5, there may be corrective action display 110, which in this example displays the message, “Too much light coming in the window. Try covering the window.” It is understood that this specific wording is by way of example and the concept may be expressed in a wide variety of ways. In this example, upon receive of the corrective action suggestion, the user may close a shade 40, as shown in FIG. 6.

In step 222, the engine 100 checks whether a corrective action was taken. This can be determined by measuring the ambient light on photosurface 300 as explained above. If no corrective action was taken, and there is too much ambient light for accurate distance measurements by camera component 22, then the engine 100 may cause the computing device 12 to display an error message in step 224.

On the other hand, if it is determined in step 222 that a corrective action was taken, the engine 100 checks in step 226 whether the corrective action ameliorated the problem of excessive ambient light. Again, this may be performed by measuring the ambient light on photosurface 300. If the problem was successfully corrected, the routine may return to step 200 and begin monitoring light anew. However, if the corrective action did not solve the problem in step 226, the engine 100 can check in step 230 whether other potential corrective actions are available (stored in memory).

If there are no other available potential corrective actions in step 230, the engine 100 may cause the computing device 12 to display an error message in step 234. If there are further potential corrective actions in step 230, the routine returns to step 218 and displays another potential corrective action. Steps 218 and 230 for suggesting one or more corrective actions may be omitted in further embodiments.

The present system allows a user solve the problem of excessive ambient light which in the past could render a device 10 inoperable. Using the ambient light feedback system described above, a user is alerted as to the existence and location of a problematic ambient light source so that the user can intervene to remove the ambient light source and solve the problem.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of detecting a problematic ambient light source using an image camera component capturing a field of view, the method comprising:
(a) measuring ambient light within the field of view;
(b) determining whether the amount of ambient light measured in said step (a) interferes with the operation of the image camera component; and
(c) alerting a user as to the existence of the problematic ambient light source if it is determined in said step (b) that the amount of ambient light measured in said step (a) interferes with the operation of the image camera component.

2. The method of claim 1, wherein said step (a) of measuring ambient light comprises the step of measuring ambient light incident on each photopixel of a photosurface within the image camera component.

3. The method of claim 1, wherein said step (a) of measuring ambient light comprises the step of measuring ambient light incident on a photosurface of a 3-D depth camera.

4. The method of claim 1, wherein said step (b) of determining whether the amount of ambient light interferes with the operation of the image camera component comprises the step of determining the number of photopixels within the image camera component that are ambient-saturated to determine whether the number of ambient-saturated photopixels exceeds a predetermined number.

5. The method of claim 1, wherein said step (b) of determining whether the amount of ambient light interferes with the operation of the image camera component comprises the step of determining whether a predetermined number of photopixels within a given cluster of photopixels are ambient-saturated.

6. The method of claim 1, wherein said step (c) of alerting a user as to the existence of the problematic ambient light source comprises the step of displaying an alert on a display.

7. The method of claim 1, wherein said step (c) of alerting a user as to the existence of the problematic ambient light source comprises the step of providing an audio alert to the user.

8. The method of claim 1, wherein said step (c) of alerting a user as to the existence of the problematic ambient light source comprises the step of displaying a representation of the problematic ambient light source together with an indication that the ambient light source is problematic.

9. The method of claim 1, wherein said step (c) of alerting a user as to the existence of the problematic ambient light source comprises the step of alerting a user as to a degree of interference of the problematic ambient light source.

10. The method of claim 1, further comprising the step of suggesting a corrective action to ameliorate the excessive ambient light from the problematic ambient light source.

11. A method of detecting a problematic ambient light source using an image camera component measuring distances to objects within a field of view, the method comprising:
(a) measuring ambient light within the field of view;
(b) determining whether photopixels of the image camera component are receiving ambient light at levels which prevent the image camera component from properly measuring distances to objects within the field of view; and
(c) alerting a user as to the existence of the problematic ambient light source if it is determined in said step (b) that photopixels of the image camera component are receiving ambient light at levels which prevent the image camera component from properly measuring distances to objects within the field of view.

12. The method of claim 11, wherein said step (b) of determining whether photopixels of the image camera component are receiving ambient light at levels which prevent the image camera component from properly measuring distances comprises the step of determining the number of photopixels within the image camera component that are ambient-saturated to determine whether the number of ambient-saturated photopixels exceeds a predetermined number.

13. The method of claim 11, wherein said step (b) of determining whether photopixels of the image camera component are receiving ambient light at levels which prevent the image camera component from properly measuring distances comprises the step of determining whether a predetermined number of photopixels within a cluster of photopixels of a given size are ambient-saturated.

14. The method of claim 11, wherein said step (c) of alerting a user as to the existence of the problematic ambient light source comprises the step of displaying a representation of the problematic ambient light source together with an indication that the ambient light source is problematic.

15. The method of claim 11, wherein said step (c) of alerting a user as to the existence of the problematic ambient light source comprises the step of displaying a first icon representing a location of the problematic ambient light source and a second icon representing a location of the user relative to the problematic light source, together with an indication that the ambient light source is problematic.

16. The method of claim 11, further comprising the step of suggesting a corrective action to ameliorate the excessive ambient light from the problematic ambient light source.

17. A 3-D camera for measuring distances to objects within a field of view of the 3-D camera, and determining the presence of a problematic source of ambient light, the 3-D camera comprising:
a photosurface including a plurality of pixels capable of measuring ambient light;
a processor for processing data received from the photosurface, and
an ambient light feedback engine executed by the processor for identifying a problematic ambient light source within the field of view from data received from the photosurface, and for alerting a user of the problematic ambient light source when identified so that the user can intervene to ameliorate the problem caused by the problematic ambient light source.

18. The 3-D camera recited in claim 17, the ambient light feedback engine identifying a problematic ambient light source when a predetermined number of photopixels within the photosurface ambient-saturated.

19. The 3-D camera recited in claim 17, wherein the 3-D camera causes the generation of a visual display indicating a location of the problematic ambient light source.

20. The 3-D camera recited in claim 17, wherein the 3-D camera is a time of flight camera.
